(19) United States
(12) Patent Application Publication
(10) Pub. No.: US 2017/0210544 A1
(43) Pub. Date: Jul. 27, 2017

(54) INDIVIDUAL PILL DISPENSER

(71) Applicant: Thomas Graziano, Bayshore, NY (US)

(72) Inventor: Thomas Graziano, Bayshore, NY (US)

(21) Appl. No.: 15/006,778

(22) Filed: Jan. 26, 2016

(51) Int. Cl. B65D 83/04; B65D 51/24; B65D 41/04; A61J 1/03; B65D 1/02

(52) U.S. Cl. CPC B65D 83/049; A61J 1/03; B65D 1/0246; B65D 41/0435; B65D 51/24; B65D 83/0409

(57) ABSTRACT

A dispenser apparatus is disclosed, and includes a container and a cap. The container includes an at least partially enclosed wall that defines an interior cavity to retain a plurality of pills therein. The at least partially enclosed wall terminates at a neck that includes a lock at least partially protruding therefrom. The neck aperture has a size that is as large or larger than a pill of the plurality of pills. The cap includes an interior recess such that the cap receives and rotationally engages the neck of the container. The cap defines a cap aperture that is rotatably alignable with the neck aperture. When the cap aperture and the neck aperture are aligned, a passage between the interior cavity of the container and an outside environment is provided so that a pill may pass therethrough.

### FIELD

The present invention generally relates to a dispenser for pills. In embodiments, the present invention is directed to a dispenser that may contain multiple pills, and is configured to dispense a single pill at a time.

### SUMMARY

In the modern age of healthcare, pills, for example, medications and nutritional supplements, are widely available and are in consistent general use. Such items are often packaged in bulk in a container from which one or more units of medication or supplement can be dispensed or withdrawn, for example, to be ingested orally by a user.

However, Applicant has discovered a need for improving conventional container/dispensers. For example, Applicant has discovered that users, particular users with challenges to manual dexterity, may desire an aid to dispense a single pill of medication or supplement so as to avoid spillage or waste. Applicant has also discovered that such users may desire a single-pill dispenser that incorporates a safety feature to provide for selective opening by a user.

According to an exemplary embodiment of the present invention, a dispenser apparatus is disclosed, comprising: a container comprising: an at least partially enclosed wall that defines an interior cavity to retain a plurality of pills therein; the at least partially enclosed wall terminates at a neck, the neck includes a lock at least partially protruding therefrom, wherein the neck aperture has a size that is as large or larger than a pill of the plurality of pills; and a cap comprising: an interior recess such that the cap receives and rotationally engages the neck of the container, the cap defines a cap aperture that is rotatably alignable with the neck aperture, wherein when the cap aperture and the neck aperture are aligned, a passage between the interior cavity of the container and an outside environment is provided so that a pill may pass therethrough.

In embodiments, the neck aperture is circular.

In embodiments, the neck aperture is ovular.

In embodiments, a channel extends along an interior surface of the cap away from the cap aperture and is configured to at least partially receive the lock.

In embodiments, when the cap aperture is rotationally aligned with the lock, at least a portion of the lock protrudes into the cap aperture to inhibit rotational movement of the cap.

In embodiments, the neck and the cap are configured to interengage one another.

In embodiments, the cap comprises an interior channel configured to receive at least a portion of the neck.

In embodiments, the neck comprises a bead extending therefrom and at least partially circumferentially extending around the neck, the bead configured to interengage an interior portion of the cap.

In embodiments, the cap comprises a sweeper mechanism that extends into an interior portion of the neck of the container.

In embodiments, the sweeper mechanism is positioned circumferentially in front of the cap aperture in a direction of rotation of the cap.

According to an exemplary embodiment of the present invention, a method of dispensing a pill is disclosed, comprising: providing a dispenser apparatus that comprises: a container comprising an interior cavity and a neck having a neck aperture therealong; a cap configured to engage the neck of the container and having a cap aperture that is rotationally alignable with the neck aperture and a sweeper mechanism extending into an interior portion of the neck; inverting the dispenser apparatus so that a plurality of pills disposed in the interior cavity are moved toward the cap; rotating the cap about the neck so that the sweeper mechanism moves one or more pills of the plurality of pills away from the neck aperture; and rotating the cap about the neck so that the cap aperture rotationally aligns with the neck aperture.

In embodiments, the neck aperture is circular.

In embodiments, the neck aperture is ovular.

In embodiments, the container further comprises a lock at least partially protruding from the neck, and wherein the cap aperture is rotatably alignable with the lock.

In embodiments, the method further comprises the step of disengaging the cap aperture from the lock.

In embodiments, the step of inverting the dispenser apparatus comprises tilting the dispenser apparatus an angle of 90 degrees or greater with respect to an upright position.

In embodiments, the sweeper mechanism is positioned circumferentially in front of the cap aperture in a direction of rotation of the cap.

According to an exemplary embodiment of the present invention, a method of dispensing a pill is disclosed, comprising: providing a dispenser apparatus that comprises: a container comprising an interior cavity and a neck having a neck aperture therealong; a cap configured to engage the neck of the container and having a cap aperture that is rotationally alignable with the neck aperture; inverting the dispenser apparatus so that a plurality of pills disposed in the interior cavity are moved toward the cap; shaking the dispenser so that one or more pills of the plurality of pills are displaced away from the neck aperture; and rotating the cap about the neck so that the cap aperture rotationally aligns with the neck aperture.

In embodiments, the neck aperture is circular.

In embodiments, the neck aperture is ovular.

### BRIEF DESCRIPTION OF THE DRAWINGS

Various exemplary embodiments of this invention will be described in detail, with reference to the following figures, wherein:

FIG. 1A is a first sequential cross-sectional view of a dispenser apparatus according to an exemplary embodiment of the present invention;

FIG. 1B is a second sequential cross-sectional view of the dispenser apparatus of FIG. 1A;

FIG. 2 is a partial cross-sectional view of the dispenser apparatus of FIG. 1A looking in a downward direction;

FIG. 3A is a first sequential cross-sectional view of the dispenser apparatus of FIG. 1A;

FIG. 3B is a second sequential cross-sectional view of the dispenser apparatus of FIG. 1A;

FIG. 3C is a third sequential cross-sectional view of the dispenser apparatus of FIG. 1A;

FIG. 4 is a flow chart directed to a method of operation of the dispenser apparatus of FIG. 1A according to an exemplary embodiment of the present invention;

FIG. 5A is a first sequential cross-sectional view of a dispenser apparatus according to another exemplary embodiment of the present invention;

FIG. 5B is a second sequential cross-sectional view of a dispenser apparatus according to another exemplary embodiment of the present invention; and

FIG. 6. is a front view of a container of a dispenser apparatus according to an exemplary embodiment of the present invention.

### DETAILED DESCRIPTION

The present invention generally relates to a dispenser for pills. In embodiments, the present invention is directed to a dispenser that may contain multiple pills, and is configured to dispense one pill at a time.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

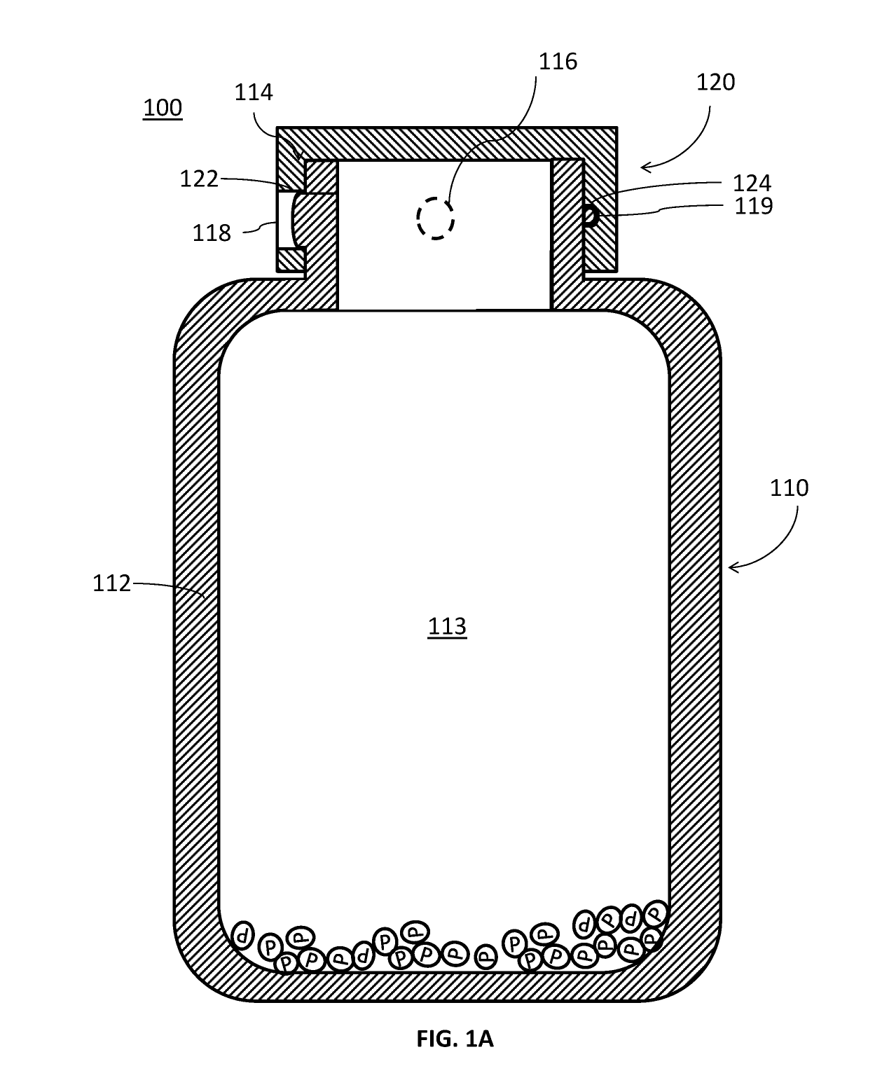

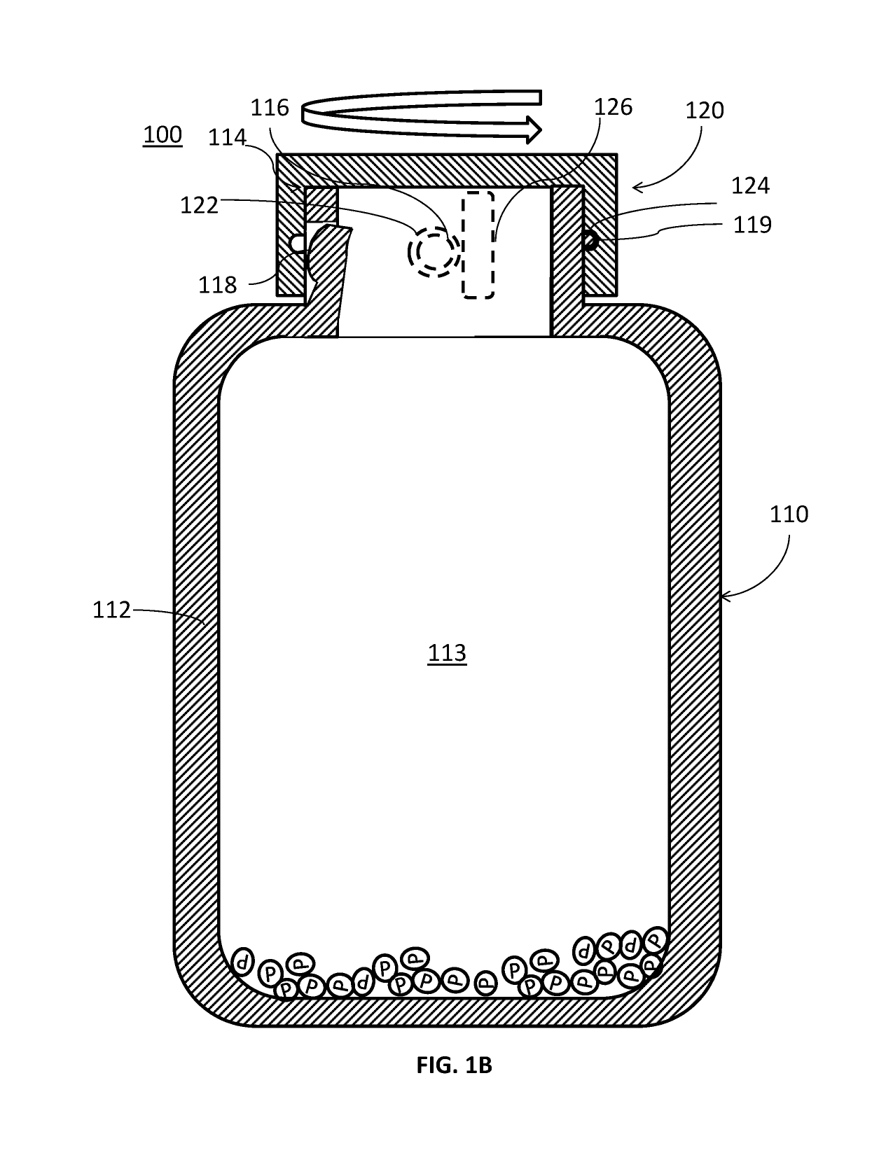

With reference to FIG. 1A, a dispenser apparatus according to an exemplary embodiment of the present invention is generally designated 100. Dispenser apparatus 100 includes a container 110 and a cap 120 that movably engages a portion of the container 110, as described further herein.

Container 110 includes a wall 112 that defines an interior cavity 113. As shown, wall 112 may be arranged in an at least partially enclosed configuration, for example a cylindrical configuration with an open end. In this regard, objects deposited into interior cavity 113 can be maintained therein until dispenser apparatus 100 is manipulated by a user in a manner to allow the exit of the one or more objects, such as pills P, which may be circular or spherical units of medication or supplements. As described herein, pills P may have a different configuration.

The wall 112 of container 110 may taper to a neck 114 toward a top end of container 110. In this regard, neck 114 may have a generally smaller diameter than the remainder of container 110. As described further herein, neck 114 and cap 120 may be configured for interengagement, for example, via press fit, snap fit, or threadable engagement, to name a few. In embodiments, cap 120 may be configured to interengage a different portion of container 110. Neck 114 of container 110 also includes an aperture 116 through which a pill P can exit container 110. In this regard, aperture 116 is at least the same size as a pill P disposed within container 110 in at least one orientation. In embodiments, aperture 116 may be sized larger than a pill P disposed within container 110.

A lock 118 may also be disposed along a portion of neck 114 of container 110. Lock 118 may include a protruding portion such as a button or dome. In embodiments, lock 118 may be supported on a stem, for example, a perforated portion or slitted portion of neck 114. Lock 118 may be at least partially deformable, e.g., collapsible or flexible, so that lock 118 may be pressed inwardly, e.g., bows inwardly to protrude at least partially through neck 114 at least partially into interior cavity 113, such that lock 118 is flush with neck 114 or recessed therein. In embodiments, lock 118 may be configured to substantially maintain its shape, for example, so that a predetermined amount of rotational force exerted on cap 120 causes a camming-type action over lock 118. In embodiments, a different locking mechanism may be used. Lock 118 may maintain cap 120 in engagement and in a substantially rotationally stationary position with respect to container 110. In this regard, lock 118 may provide for selective opening of dispenser apparatus 100 and/or may provide a safety measure against, for example, accidental or inadvertent opening of dispenser apparatus 100.

Still referring to FIG. 1A, a bead 119 may be disposed at least partially around neck 114, and, as described further herein, may be positioned to engage a portion of cap 120. Bead 119 may be a protruding portion of neck 114, and may be disposed around neck 114 at the same or a similar vertical position as lock 118. Accordingly, lock 118 may be circumferentially positioned between sections of bead 119 along neck 114. In embodiments, bead 119 may have one or more additional discontinuities along neck 114. Bead 119 may be formed for example, as an integral portion of neck 114, e.g. a molded portion, or may be a separate element attached to neck 114 such as a sealing ring. Cap 120 may snap over bead 119 so that cap 120 is maintained on container 110.

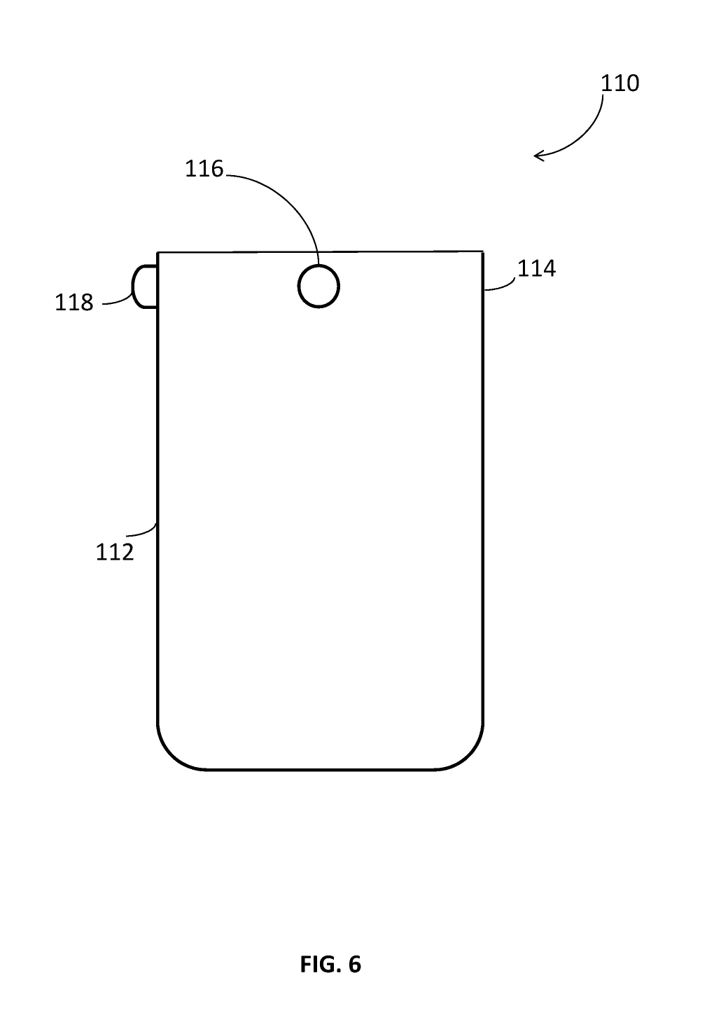

Referring momentarily to FIG. 6, in an exemplary embodiment, container 110 may have a wall 112 that terminates at a neck 114 that is a substantially similar diameter as that of the wall 112. In this regard, container 110 has a generally tubular configuration. Aperture 116, lock 118, and bead 119 may be disposed around the neck 114 as described above in this configuration.

Referring again to FIG. 1A, cap 120 may be a circular member that defines an opening and an interior recess for receiving a portion of neck 114 of container 110. In this regard, cap 120 may be complementary to the configuration of neck 114. Cap 120 includes an aperture 122 configured to receive at least a portion of lock 118 when aperture 122 is aligned therewith. In this regard, when dispenser apparatus 100 is in a closed configuration, lock 118 may protrude into aperture 122 such that lock 118 inhibits circumferential movement of cap 120 about neck 114 of container 110, as described further herein. The relative dimensions, e.g., tolerance, between cap 120 and container 110 may determine an amount of rotational force required to rotate cap 120 about neck 114 in addition to the presence of lock 118 As described above, a predetermined amount of force may cause the sides of cap 120 adjacent aperture 122 to cam over lock 118 so that cap 120 moves to an unlocked position.

Cap 120 may also include an interior channel 124 extending at least partially around an interior surface of cap 120 and positioned at a vertical level with lock 118 and/or bead 119. In this regard, cap 120 may be configured such that lock 118 abuts and/or partially enters channel 124 when dispensing apparatus 100 is in an open configuration. Additionally, one or more portions of bead 119 may be disposed within channel 124 in an open configuration of dispensing apparatus 100. As shown, bead 119 may have smaller dimensions than lock 118 so that bead 119 does not present an obstacle to rotation of cap 120 about neck 114, but the position of bead 119 within the channel 124 of cap 120 may inhibit vertical separation of cap 120 from container 110.

Channel 124 may permit substantially uninhibited rotation of cap 120 relative to container 110 along a selected circumferential distance of cap 120. In this regard, channel 124 may be dimensioned and/or positioned to permit a predetermined degree of rotational movement about neck 114. For example, channel 124 may extend fully around cap 120, or may extend partially around cap 120 with a terminus that forms or includes a stop to inhibit further rotation, e.g., so that cap 120 can only be turned a quarter turn, half turn, or other fractional turn relative to container 110.

Aperture 122 may also have at least the same dimensions as a largest cross-sectional area of pills P disposed within interior cavity 113 of container 110, e.g., aperture 122 may have similar dimensions to aperture 116 on neck 114 of container 110. Aperture 122 may be positioned on cap 120 such that aperture 122 on the cap 120 may be aligned with aperture 116 on neck 114 by rotating cap 120 about neck 114, as described further herein.

Cap 120 may also include a sweep mechanism 126 that is disposed adjacent at least one side of aperture 122. Sweep mechanism 126 may be an interior protrusion of cap 120, for example, from a top interior surface of cap 120, that is disposed circumferentially adjacent aperture 122 and, upon coupling with container 110, is disposed circumferentially adjacent aperture 116 on neck 114 of container 110. In this regard, sweep mechanism 126 may be integrally formed, e.g., molded, with the remainder of cap 120. As shown, sweep mechanism 126 may extend substantially along a vertical height of cap 120. In embodiments, sweep mechanism 126 may be integrally formed during fabrication of cap 120, or may be coupled with the remainder of cap 120, for example, through adhesion, welding, or interference fit. Sweep mechanism 126 may be interiorly spaced from an outer wall of cap 120 at least a distance sufficient to accommodate neck 114 upon coupling of container 110 and cap 120. Sweep mechanism 126 is configured to displace pills P in excess of a single pill P intended for dispensation upon rotational approach with aperture 122, as described further herein, so that optimally only a single pill is disposed at a time.

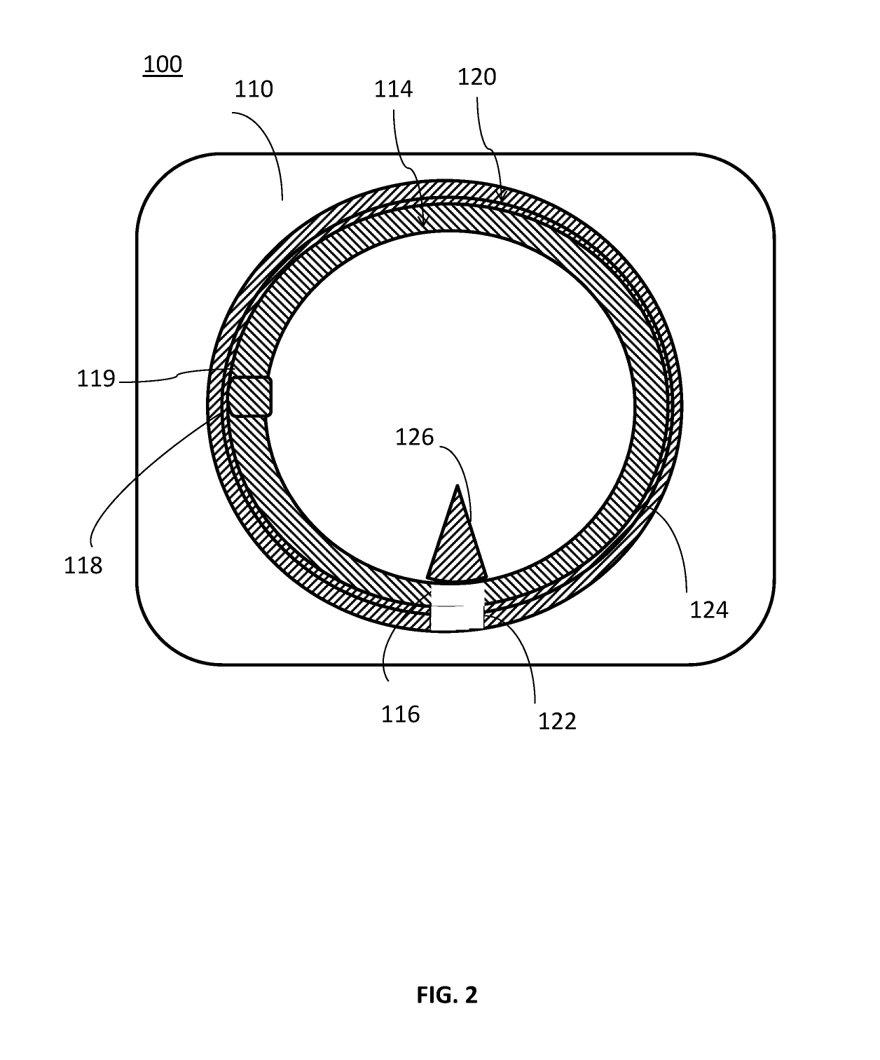

Still referring to FIG. 1A, and turning additionally to FIG. 1B and FIG. 2, operation of cap 120 will be described. With dispenser apparatus 100 in a locked position, e.g., with aperture 122 of cap 120 aligned with lock 118 such that a portion thereof protrudes from neck 114 into aperture 122 (shown best in FIG. 1A), a user may rotate cap 120 such that the edges of aperture 122 cam over lock 118 or otherwise disengage lock 118 from aperture 122. At this point, a user may rotate cap 120, e.g., twist, cap 120 about the neck 114 of container 110. It will be understood that dispenser apparatus 100 may be locked by reversing the steps described above, e.g., cap 120 may be rotated about the neck 114 such that aperture 122 aligns with lock 118 to allow the lock 118 to engage aperture 122. This may occur through a camming-type action in which the surface edges of cap 120 that define aperture 122 slide over a surface of the lock 118 such that lock 118 snaps or clicks into position within aperture 122.

Once dispenser apparatus 100 has been unlocked in the manner described above, cap 120 may be rotated such that aperture 122 aligns with aperture 116 on neck 114. With aperture 116 and aperture 122 aligned, a passage between the interior recess 113 of container 110 and an exterior environment is provided. Accordingly, a user may invert, shake, and/or otherwise manipulate dispenser apparatus 100 such that a pill disposed therein moves toward and travels through apertures 116, 122, e.g., in a dispensing operation.

However, in instances in which multiple pills P are disposed within dispenser apparatus 100, more than one pill P may approach apertures 116, 122 upon inversion of dispenser apparatus 100 such that multiple pills P may interfere with one another's exit through apertures 116, 122. Accordingly, a method of using dispenser apparatus 100 involving sweep mechanism 126 is provided herein.

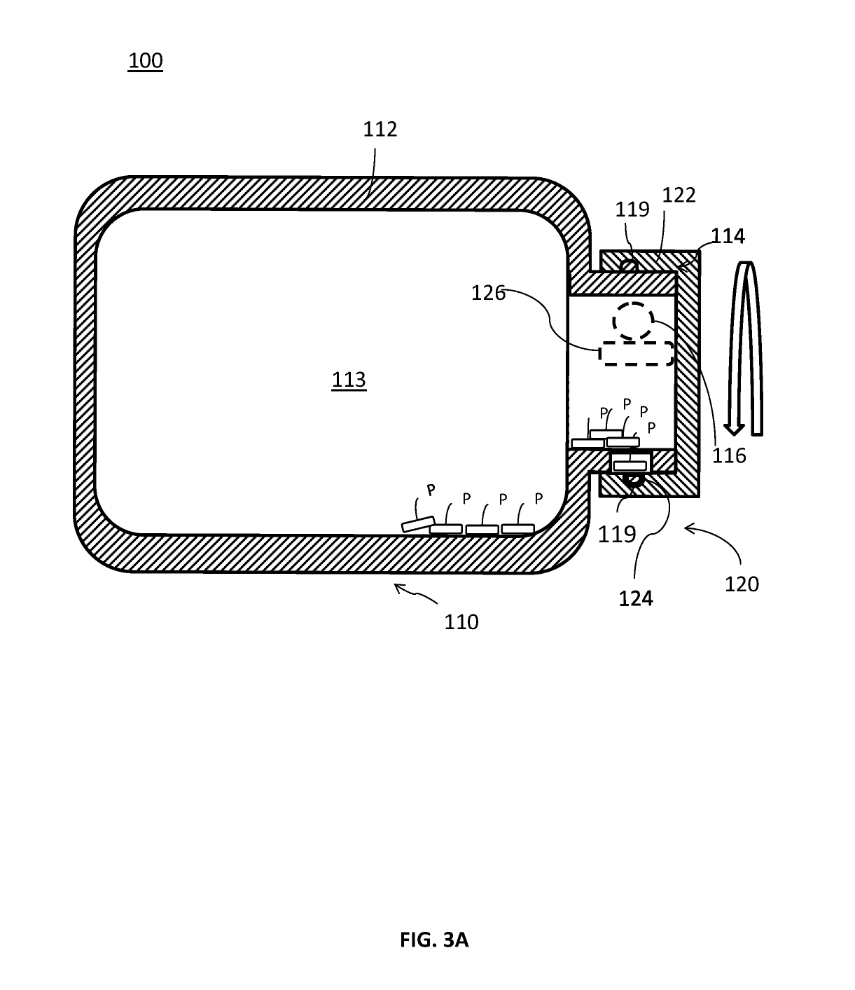

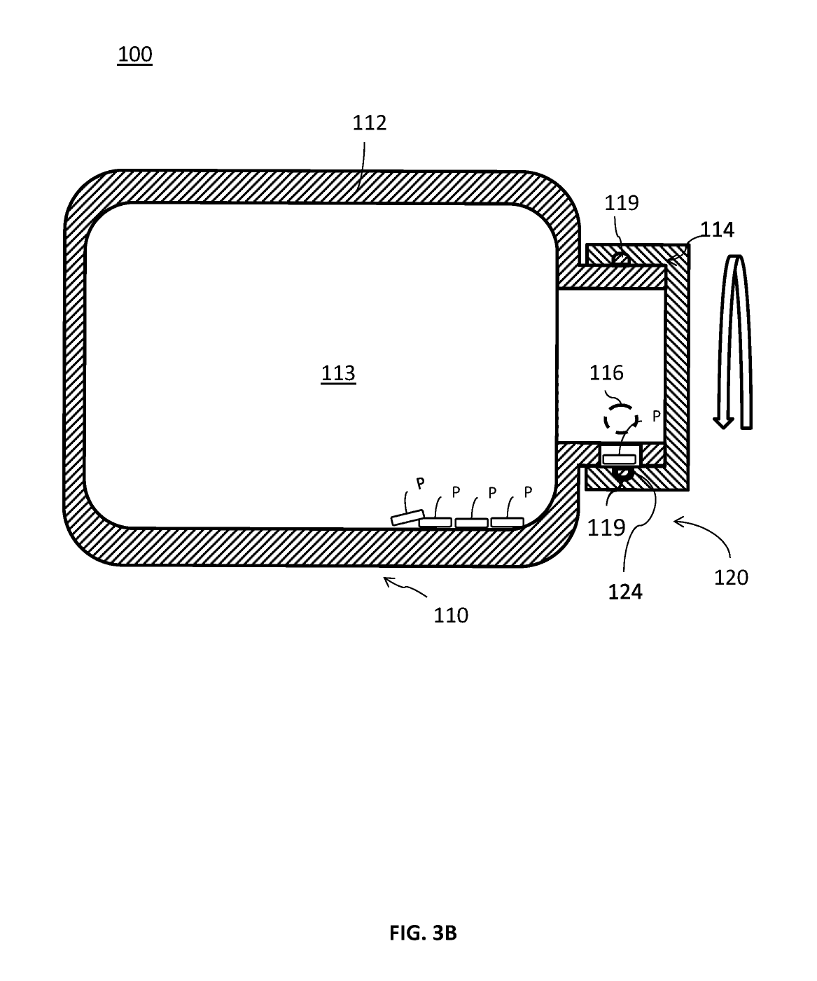

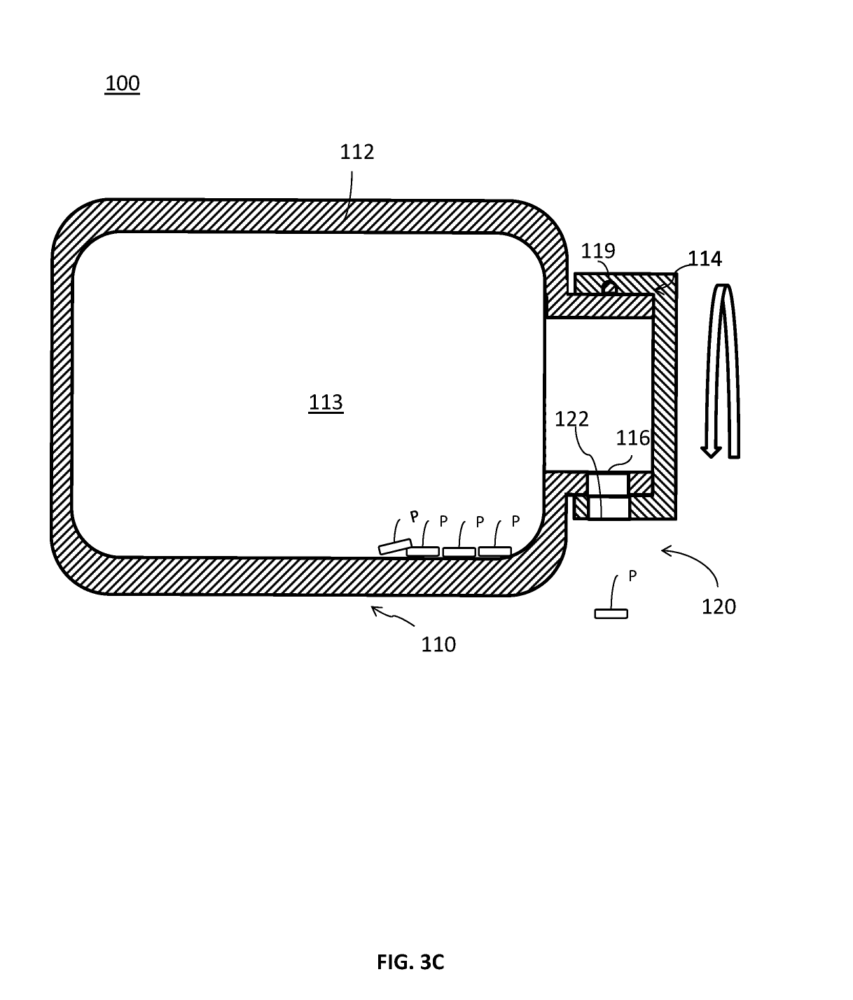

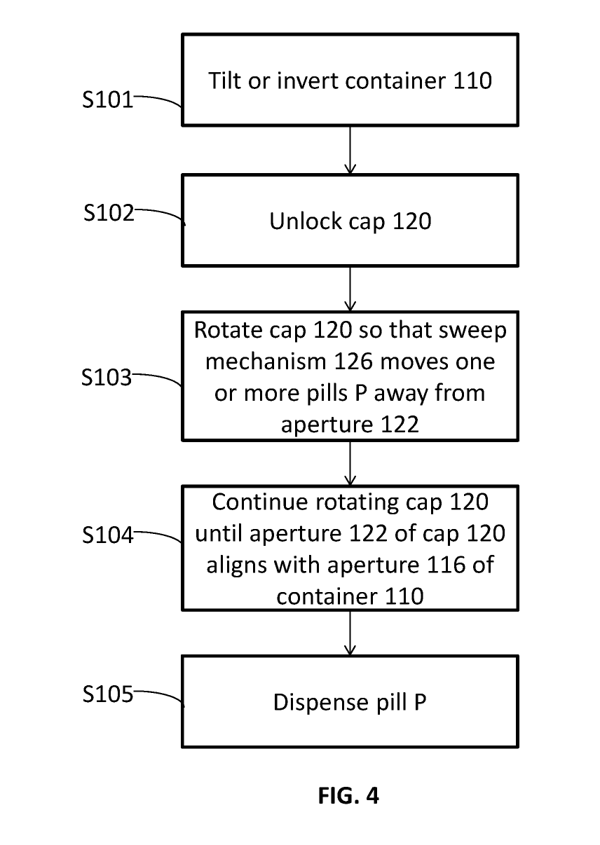

With reference to FIGS. 3A, 3B, and 3C, and with additional reference to FIG. 4, a method of using dispenser apparatus 100 to ensure the orderly and singular dispensing of a single pill P at a time will be described. FIGS. 3A-3C are shown from a side orientation with respect to FIGS. 1A and 1B described above.

In a step S101, a user may grasp dispenser apparatus 100 containing multiple pills P and invert, e.g., tilt or turn to an angle, for example, an angle equal to or greater than 90° relative to an upright position, dispenser apparatus 100 as shown, e.g., by grasping and tilting or turning container 110. Upon inversion of dispenser apparatus 100, pills P will approach the neck 114 of container 110 and accumulate therein, stopped from further movement by the presence of cap 120 over the neck 114.

In a step S102, the user may grasp cap 120 and unlock cap 120 so that cap 120 can be rotated about neck 114 of container 110. As described above, cap 120 and container 110 may be configured such that a user can disengage lock 118 from aperture 122 by exerting a predetermined amount of rotational force on cap 120 so that the edges of cap 120 adjacent aperture 122 cam over lock 118 to permit further rotation of cap 120. The arrangement of cap 120 and container 110 may be selected such that a user with limited manual dexterity or strength, for example, a recovering stroke victim or arthritis patient, may be able to unlock cap 120 in this fashion with, for example, a loose grip on container 110 with one hand and a loose grip on cap 120 with the other hand. Such an arrangement provides for a selective opening of dispenser apparatus 100 by virtue of the lock 118, but also facilitates ease of access by populations with limited manual dexterity or strength.

In a step S103, the user may further rotate cap 120 such that sweep mechanism 126 of cap 120 approaches aperture 116 along the interior of neck 114 of container 110. In this regard, sweep mechanism 126 causes one or more pills P to be pushed past aperture 116 along neck 114 of container 110 as the aperture 122 of cap 120 approaches alignment with aperture 116 ahead of aperture 122 of cap 120. As described herein one or both of apertures 116, 122 may be dimensioned, e.g., have a thickness, such that a single pill P may become at least partially recessed therein during the aforementioned sweeping action of sweep mechanism 126 such that at least one pill P is not swept forward with the rotation of cap 120. In embodiments, for example, embodiments in which a sweep mechanism may not be present, a user may gently shake or otherwise disturb container 110 so that a plurality of pills P are moved away from apertures 116, 122, with a single pill P remaining positioned for exit therethrough.

In a step S104, the user continues rotation of cap 120 such that aperture 122 of cap 120 aligns with aperture 116 of neck 114. Upon such alignment, in a step S105, a single pill P is provided a substantially unrestricted passage to exit dispenser apparatus 100, for example, into the palm of a user or onto a surface such as a table surface for later retrieval by the user.

In embodiments, aperture 122 may be larger than aperture 116 on neck 114. In this regard, a generic cap 120 may be paired with containers 110 with apertures 116 of variable size, as long as apertures 116 are as large as or smaller than aperture 122. Alternatively, the aperture 116 on neck 114 may be larger than the aperture 122 on the cap 120 to enable a generic container 110 to be used and an appropriate cap 120 to be selected to uniformly disperse pills of a specific size. Either arrangement may be desirable, for example, to streamline manufacturing efforts.

The position of lock 118 on neck 114 relative to the position of aperture 116 may facilitate the locking and dispensing operations of dispenser apparatus 100 described above. While lock 118 and aperture 116 are shown disposed about 90 degrees relative to one another, other relative positions for these components may be used, for example, 45 degrees, 135 degrees, or 180 degrees, to name a few. In embodiments, container 110 and cap 120 may be configured such that cap 120 may be rotated along a predetermined range with respect to container 110. In embodiments, cap 120 may include one or more additional openings such that aperture 122 may need not be used for alignment and/or engagement with both the lock 118 and aperture 116.

In embodiments, additional features may be provided with lock 118 to facilitate operation of container 110. For example, one or more stops may be provided on an interior surface of cap 120 such that lock 118 may inhibit rotation of cap 120 beyond a predetermined range. Such a configuration may be used to allow a limited range of rotation for cap 120, for example, to avoid confusion of a user or to prevent disassembly of cap 120 from container 110.

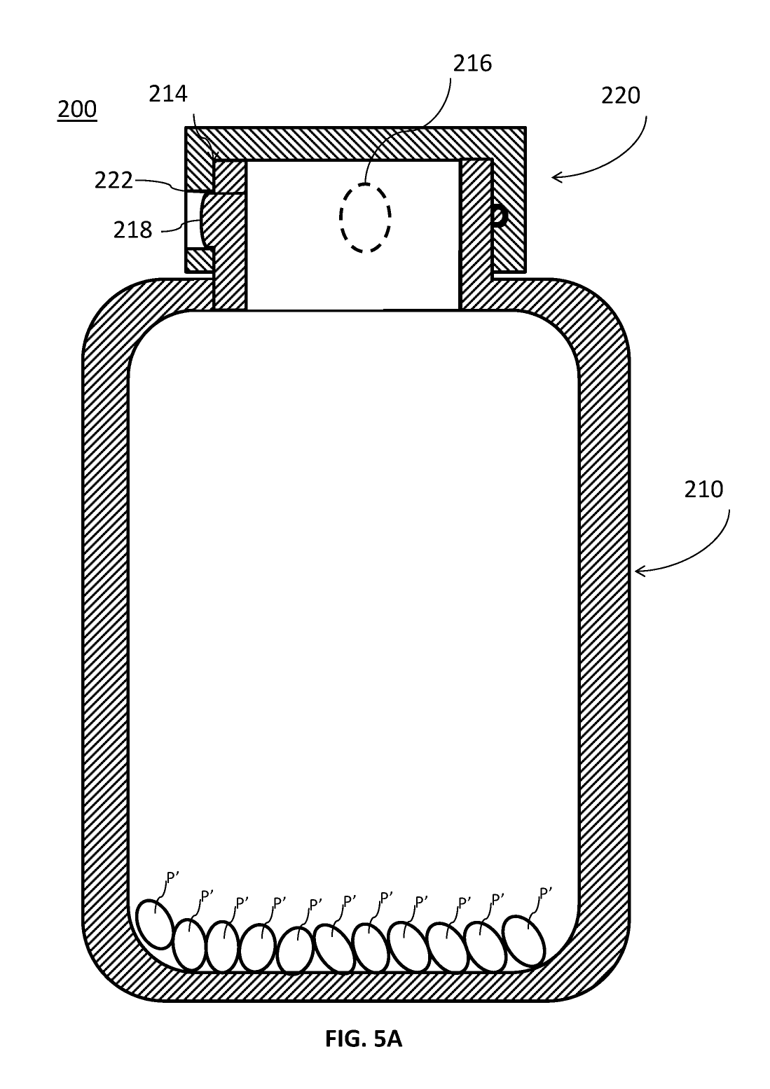

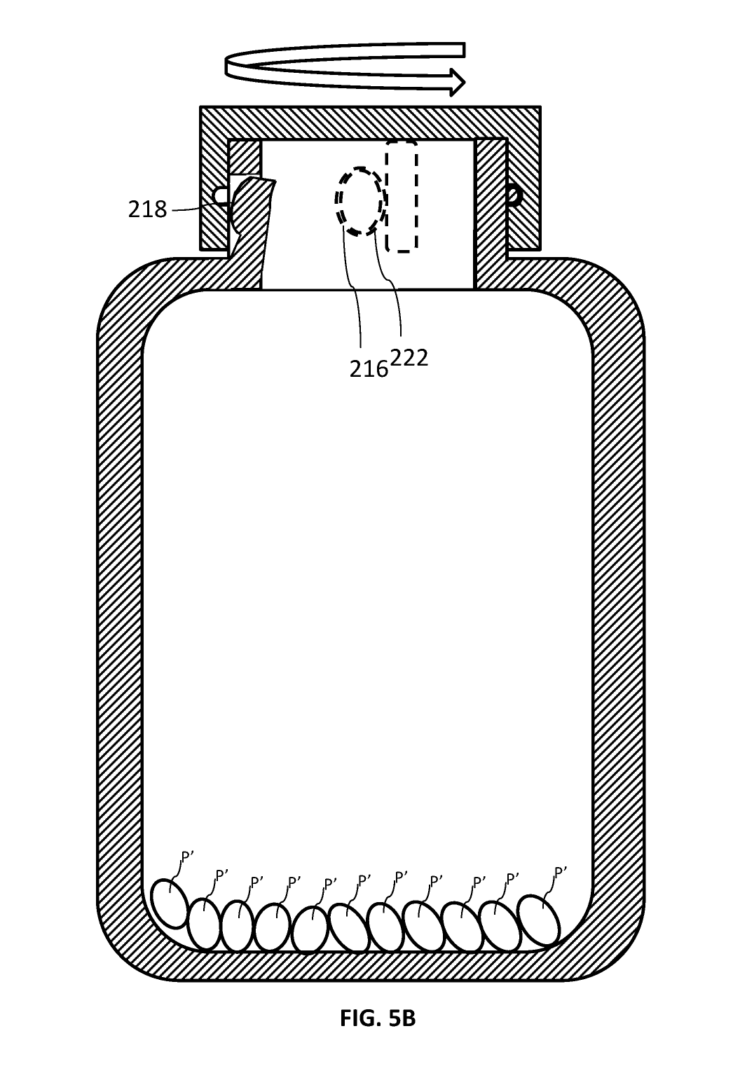

Referring to FIGS. 5A and 5B, another embodiment of a dispenser apparatus is generally designated 200. Dispenser apparatus 200 may have substantially similar components to dispenser apparatus 100 described above, and may include a neck aperture 216 and a cap aperture 222 that align to allow the dispensation of pills of a different shape and/or size than pills P described above. As shown, ovular cap aperture 222 rotationally aligns with ovular neck aperture 216 on a neck 214 of container 210 so that dispenser apparatus 200 is configured to retain and dispense pills P′ having an ovular configuration. In embodiments, a dispenser apparatus 200 may be provided with openings to facilitate the dispensation of a different type of pill, for example, a square or rectangular pill, a pentagonal pill, a hexagonal pill, a spherical pill, or an octagonal pill, to name a few.

While this invention has been described in conjunction with the embodiments outlined above, it is evident that many alternatives, modifications and variations will be apparent to those skilled in the art. For example, the components of the dispenser apparatuses disclosed herein may be at least partially formed of materials such as polymeric materials and/or composite materials. Accordingly, the exemplary embodiments of the invention, as set forth above, are intended to be illustrative, not limiting. Various changes may be made without departing from the spirit and scope of the invention.

1. A dispenser apparatus, comprising:
a container comprising:
an at least partially enclosed wall that defines an interior cavity to retain a plurality of pills therein;
the at least partially enclosed wall terminates at a neck configured to receive a cap, the neck further comprising a lock at least partially protruding therefrom and being movable in a direction toward the interior cavity;
a neck aperture on the neck that has a size that is as large or larger than a pill of the plurality of pills to be retained in the interior cavity; and
a cap comprising:
an interior recess such that the cap receives and rotationally engages the neck, the cap defines a cap aperture that is selectively rotatably alignable with the neck aperture and with the lock, wherein when the cap aperture and the neck aperture are aligned, a passage between the interior cavity of the container and an outside environment is provided so that a pill may pass therethrough, whereas, when the cap aperture is aligned with the lock, circumferential movement of the cap in either direction is inhibited.

2. The dispenser apparatus of claim 1, wherein the neck aperture is circular.

3. The dispenser apparatus of claim 1, wherein the neck aperture is ovular.

4. The dispenser apparatus of claim 1, wherein a channel extends along an interior surface of the cap away from the cap aperture and is configured to at least partially receive the lock.

5. The dispenser apparatus of claim 1, whereby the lock is supported on a stem such that when the cap aperture is aligned with the lock, at least a portion of the lock protrudes into the cap aperture to inhibit rotational movement of the cap, whereas when the cap aperture is aligned with the neck aperture, the stem is pressed inwardly to protrude at least partially into the interior cavity, thereby releasing the lock.

6. The dispenser apparatus of claim 1, wherein the neck and the cap are configured to interengage one another.

7. The dispenser apparatus of claim 6, wherein the cap comprises an interior channel configured to receive at least a portion of the neck.

8. The dispenser apparatus of claim 6, wherein the neck comprises a bead extending therefrom and at least partially circumferentially extending around the neck, the bead configured to interengage an interior portion of the cap.

9. The dispenser apparatus of claim 1, wherein the cap comprises a sweeper mechanism that extends into an interior portion of the neck of the container.

10. The dispenser apparatus of claim 9, wherein the sweeper mechanism is positioned circumferentially in front of the cap aperture in a direction of rotation of the cap.

11. A method of dispensing a pill, comprising:
providing a dispenser apparatus that comprises: a container comprising an interior cavity and a neck having a lock comprising a protruding portion of the neck and a neck aperture; a cap configured to engage the neck having a cap aperture that is alignable with the lock when the cap is in a first rotational position and whereby the cap aperture is alignable with the neck aperture when the cap is in a second rotational position, whereby in the first rotational position the lock at least partially inserts into the cap aperture and inhibits rotation of the cap in either direction;
inverting the dispenser apparatus so that a plurality of pills disposed in the interior cavity are moved toward the cap; and
rotating the cap about the neck from the first rotational position to the second rotational position so that the cap aperture aligns with the neck aperture.

12. The method of claim 12, wherein the neck aperture is circular.

13. The method of claim 11, wherein the neck aperture is ovular.

14. The method of claim 11, wherein the container further comprises a lock at least partially protruding from the neck, and wherein the cap aperture is rotatably alignable with the lock.

15. The method of claim 14, further comprising the step of disengaging the cap aperture from the lock.

16. The method of claim 11, wherein the step of inverting the dispenser apparatus comprises tilting the dispenser apparatus an angle of 90 degrees or greater with respect to an upright position.

17. The method of claim 11, further comprising a sweeper mechanism positioned circumferentially in front of the cap aperture in a direction of rotation of the cap.

18. A method of dispensing a pill, comprising:
providing a dispenser apparatus that comprises: a container comprising an interior cavity and a neck having a neck aperture therealong, the neck further comprising a lock that is movable in a direction toward the interior cavity; a cap configured to engage the neck and having a cap aperture that is rotationally alignable with the neck aperture;
inverting the dispenser apparatus so that a plurality of pills disposed in the interior cavity are moved toward the cap;
shaking the dispenser so that one or more pills of the plurality of pills are displaced away from the neck aperture; and
rotating the cap about the neck so that the cap aperture rotationally aligns with the neck aperture.

19. The method of claim 18, wherein the neck aperture is circular.

20. The method of claim 18, wherein the neck aperture is ovular.
